(19) United States
(12) Patent Application Publication
(10) Pub. No.: US 2001/0024949 A1
(43) Pub. Date: Sep. 27, 2001

(54) Jacket with multiband transmitter-receiver function and system using the same

(75) Inventors: Yo Yanagida, Shizuoka-ken (JP); Kazuyuki Osada, Shizuoka-ken (JP); Terumitsu Sugimoto, Shizuoka-ken (JP); Satoshi Negishi, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: Yazaki Corporation.

(21) Appl. No.: 09/805,032

(22) Filed: Mar. 14, 2001

(30) Foreign Application Priority Data
Mar. 14, 2000 (JP) P 2000-70907

(51) Int. Cl. H04M 11/00

(52) U.S. Cl. 455/404; 455/456; 455/552; 455/66

(57) ABSTRACT

A jacket with a multiband transmitter-receiver is constituted of: an antenna section 1 comprising a TV/radio (AM/FM) antenna 2, a mobile phone antenna 3, a transceiver antenna 4 and a GPS antenna 5; a multiband transmitter-receiver 6 having a universal tuner 7 and a control means 8; an I/O section 9 comprising a short-distance radio and a cable connector; a human interface section 10; and a sensor section 11, with these equipments attached respectively to the jacket.

### BACKGROUND OF THE INVENTION

The present invention relates to a jacket with a multiband transmitter-receiver function that can utilize various communication services, and more specifically, relates to a jacket with a multiband transmitter-receiver function, which is not a hindrance to carrying, and always provides a position and health status of a wearer of the jacket without being sensible of carrying it, and a system using the jacket.

A communication apparatus, which does not become a hindrance to carrying and does not have to be sensible of carrying it, is disclosed in, for example, Japanese Unexamined Patent Publication No. H9-284824. The prior art disclosed in this publication is a radio paging receiver of a nameplate type in which a nameplate and a receiver are integrally constructed, which comprises a receiving antenna, a demodulator circuit, a receiving part having a reception control circuit and an ID code memory circuit, a call informing section having an LED, a piezobuzzer and the like, and a power source/power feed control section, and it is constructed such that intermittent reception is performed in order to reduce consumption power.

When the receiving antenna receives a signal, the demodulator circuit in the receiving part demodulates the signal into a signal in bit strings, and the reception control circuit decodes the signal in bit strings to extract an ID code, and compares the ID code with the own ID code stored beforehand in the ID code memory circuit. When the received ID code agrees with the own ID code, the reception control circuit makes the LED in the call informing section light up, and makes the piezobuzzer singing.

The above described prior art is for calling a person who carries the receiver built in the nameplate, and has only a receiving function.

Moreover, as equipments capable of using various communication services, there can be mentioned, for example, transceiver, mobile phone, GPS, TV, radio or the like. It is possible to carry these equipments and receive a communication service, utilizing the function or application function of the equipment itself. However, since a transmitter/receiver (baseband processing) or the like is necessary for each communication line (antenna), the apparatus becomes large, lacking a portability.

Furthermore, if a health person meets with a disaster when climbing mountain, at sea or the like, or if a person having a chronic disease exacerbates the disease while being out, when being conscious, the person can inform the matter by the mobile phone or the like, but when being unconscious, there has been heretofore no means of informing the condition of the person.

### SUMMARY OF THE INVENTION

The present invention has been completed in order to solve the above problems, and it is an object of the present invention to provide a jacket with a multiband transmitter-receiver function, which is not a hindrance to carrying, and which can utilize various communication services without being sensible of carrying it.

A first aspect of the present invention provides a jacket with a multiband transmitter-receiver function, comprising: an antenna section having various antennas; a sensor section for reading data such as at least temperature and heart rate of a wearer; a multiband transmitter-receiver comprising a universal tuner for performing data set of a signal transmitted and received by the various antennas, and a control section for receiving and controlling data detected by the sensor section; and a human interface section intervening in exchange of information between the multiband transmitter-receiver and the wearer The antenna section is provided in the upper part of the jacket, and comprises at least a GPS antenna and a mobile phone antenna. The control section comprises: an emergency judgment section for regularly gathering the data received in the sensor section, and comparing the data value with a predetermined value to thereby judge a state of emergency; a voice conversion section for spreading the data value in speech from a speaker, when it is judged to be a state of emergency by the emergency judgment section; a position information acquisition section for acquiring a position of the jacket, using the GPS data from the GPS antenna; and a data transmission section for transmitting to the outside various data from the various sensors, the position of the jacket, and the date and time as the gathered data.

A second aspect of the present invention provides a jacket with a multiband transmitter-receiver function according to the first aspect, wherein the various data are transmitted upon receiving a transfer request from an external device.

A third aspect of the present invention provides a jacket with a multiband transmitter-receiver function according to the second aspect, wherein when the external terminal is a mobile phone, the gathered data is converted to speech and transmitted.

A fourth aspect of the present invention provides a jacket with a multiband transmitter-receiver function according to the first aspect, wherein the emergency judgment section judges a state of emergency, when a reset signal from the controller is not input, even after a predetermined time has passed since the sensor value exceeded a predetermined value.

A fifth aspect of the present invention provides a jacket with a multiband transmitter-receiver function according to the first aspect, wherein the data transmission section transmits the stored gathered data via the antenna section, when the emergency judgment section judges a state of emergency.

A sixth aspect of the present invention provides a jacket with a multiband transmitter-receiver function according to the first aspect, wherein the sensor section has at least a temperature detection sensor and a heart rate detection sensor.

A seventh aspect of the present invention provides a jacket with a multiband transmitter-receiver function according to the first aspect, wherein the human interface section has at least a speaker and a controller having various operation keys.

An eighth aspect of the present invention provides a jacket with a multiband transmitter-receiver function according to the first aspect, wherein the universal tuner realizes data set of a signal transmitted and received by the various antennas, using a small and light transmission control IC.

That is to say, according to an embodiment of the jacket with a multiband transmitter-receiver function of the present invention, since an antenna section, a controller having various operation keys, a speaker, a signaling section, a temperature detection sensor, a heart rate detection sensor and a control means are provided, respectively, in an optimum position of the garment, these are not a hindrance to carrying, and various communication services can be used without being sensible of carrying it.

Moreover, since the sensor name and an output value are spread from the speaker, when the output from the sensor detecting the conditions of the body exceeds a predetermined value stored beforehand, a person who is nearby or a person wearing the jacket can take the most suitable measure immediately.

In addition, since the position information, the conditions of the body, the date and time are transmitted to the outside as the gathered data, the conditions of the person who wears the jacket can be always monitored from outside.

Furthermore, when the GPS information is input via the antenna section for each predetermined time, the information is taken into to thereby acquire and store the position. As a result, when it is judged to be a state of emergency, the stored position information and geographical information at the time of emergency can be transmitted to a predetermined hospital, a fire station and the person's house via the signaling section and the antenna section, enabling treatment or search of the jacket wearer quickly.

Also, since the results of various sensors and the position are transmitted in speech to the mobile phone, for example, the conditions of the jacket wearer can be easily grasped at home.

For example, the temperature of the jacket wearer detected by the temperature detection sensor is stored, and compared with preliminarily set data, and when it is judged to be a state of emergency from this comparison result, the information including the stored temperature and the temperature at the time of emergency is transmitted to a predetermined hospital or the wearers house via the signaling section and the antenna section. As a result, there is an effect that treatment or search of the jacket wearer can be quickly performed.

Moreover, the heart rate of the garment wearer detected by the heart rate detection sensor is stored, and when it is judged to be abnormal from the heart rate, a speech signal for calling to the garment wearer is output to the speaker via the signaling section. If there is no response through the controller, it is judged to be an emergency, and the information of the stored heart rate and the heart rate at the time of emergency is transmitted to a predetermined hospital and the wearers house via the signaling section and the antenna section. As a result, there is an effect that treatment or search of the jacket wearer can be quickly performed.

In addition, when a water detection sensor detects water level higher than a predetermined level, it is judged that the garment wearer dropped into the water, and the information of that matter and the position information are transmitted to a predetermined hospital, a fire station or the wearers house via the antenna section. As a result, there is an effect that treatment or search of the jacket wearer can be quickly performed.

Alternatively, when a vibration detection sensor detects vibrations, it is judged that the garment wearer encountered an unforeseen accident, and the information of that matter and the position information are transmitted to a predetermined hospital, a fire station or the wearers house via the antenna section. As a result, there is an effect that treatment or search of the jacket wearer can be quickly performed.

A ninth aspect of the present invention provides a system comprising: a jacket provided with an antenna section having multiple kinds of antennas, a controller having various operation keys, a speaker, a signaling section, a temperature detection sensor, a heart rate detection sensor, and control means having a small and light transmission control IC for performing data set of a signal by the antenna section, respectively, in the optimum positions of the jacket, for regularly gathering and transmitting the information of these sensors; and various external devices for communicating via a network.

The external devices comprise a geographical information system, and have means for decoding the position information in the gathered data from the jacket, opening a map screen of the area at that position, and displaying the position by color; and means for receiving the gathered data and displaying the data in a graph format corresponding to the gathered data.

Therefore, according to the system of the ninth aspect, there can be obtained an effect that the state and the position of the jacket wearer can be easily grasped on the terminal (center) side.

Moreover, a tenth aspect provides a system comprising a jacket provided with an antenna section having various kinds of antennas, a controller having various operation keys, a speaker, control means having a small and light control IC for performing data set of a signal by the various antennas, a temperature detection sensor, and a heart rate detection sensor, respectively, in the optimum positions of the jacket, for regularly gathering and transmitting the information of these sensors; a network; and a provider for distributing the gathered data to various external devices accessed thereto.

The provider comprises a geographical information system, and having: means for decoding the position information in the gathered data from the jacket, allocating the position in a map of the area at that position, and upon receiving a request from the external devices, providing the gathered data in a format corresponding to the request from the external devices; and means for charging a fee, when the system provides the gathered data in response to an access from the external devices.

According to the system of the tenth aspect, the provider gathers the gathered data from the jacket, and provides a map showing the position of the jacket wearer and the data of the sensors indicating the conditions of the body in a graph, or by converting the data into speech, when the external device makes an access to the system, As a result, there can be obtained an effect that the conditions of the jacket wearer can be known, at any time and at the same time, for example, by a monitoring center (hospital), home, mass communication or the like, Also, the provider charges with respect to an account of the owner of the accessed terminal, at the time of providing the gathered data from the jacket.

### BRIEF DESCRIPTION OF THE DRAWINGS

FIG. 1 is a schematic block diagram of a jacket with a multiband transmitter-receiver according to a first embodiment of the present invention.

FIG. 2 is a sketch drawing showing positions where respective equipments are attached, in the case where a wearable multiband transmitter-receiver is provided in a jacket 12.

FIG. 3 is a block diagram of a system in a second embodiment,

FIG. 4 is a diagram showing a communication sequence between the center and the jacket, using the second embodiment,

FIG. 5 is a diagram showing a communication sequence between the jacket and a mobile phone, using the second embodiment.

FIG. 6 is a block diagram of a system in a third embodiment.

FIG. 7 is a diagram showing a communication sequence in the third embodiment.

### DESCRIPTION OF THE PREFERRED EMBODIMENTS

<First Embodiment>

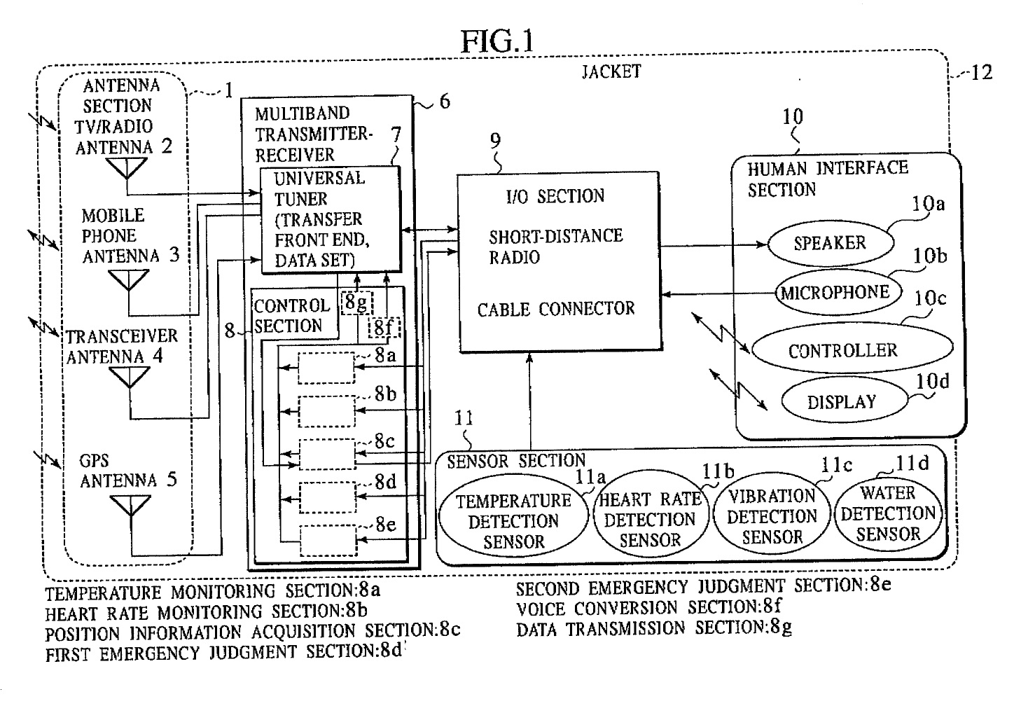

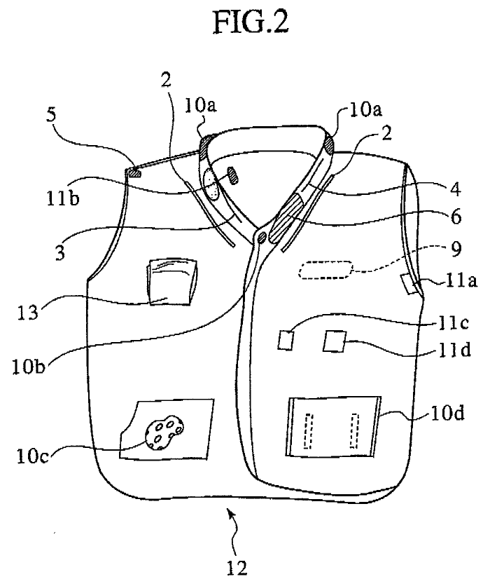

FIG. 1 is a schematic block diagram of a jacket with a multiband transmitter-receiver (also referred to as a wearable multiband transmitter-receiver) according to the first embodiment. FIG. 2 is a sketch drawing showing positions where respective equipments are attached, in the case where the wearable multiband transmitter-receiver is provided in the jacket 12.

This wearable multiband transmitter-receiver is constituted of: an antenna section 1 comprising a TV/radio (AM/FM) antenna 2, a mobile phone antenna 3, a transceiver antenna 4 and a GPS antenna 5; a multiband transmitter-receiver 6 having a universal tuner 7 and a control means 8; an 1/0 section 9 comprising a short-distance radio and a cable connector; a human interface section 10; and a sensor section 11, with these attached respectively to the jacket 12 described below.

It is preferable that the above-described antenna section 1 is attached to the upper part of the jacket 12, as shown in FIG. 2. It is also preferable that the GPS antenna 5 is built in a shoulder portion of the jacket 12.

The human interface section 10 comprises, for example, a speaker 10a, a microphone 10b, a controller 10c (with key buttons) capable of single-hand operation, and a liquid crystal display 10d, and the controller 10c and the liquid crystal display 10d have a wireless structure, The sensor section 11 comprises, for example, a temperature detection sensor 11a, a heart rate detection sensor lib, a vibration detection sensor 11c for detecting vibrations when the wearer falls from a high place or the like, and a water detection sensor 11d for detecting water when the wearer falls into the sea or a river.

The universal tuner 7 in the multiband transmitter-receiver 6 has a tuning function of each antenna, a data set function and a front end function. When information is received via the antenna section 1, the universal tuner 7 tunes and demodulates the information, and outputs the tuned and demodulated information to the speaker 11a or the liquid crystal display 10d via the I/O section 9. Moreover, the universal tuner 7 modulates the information from the microphone 10b and the controller 10b, and the information from the control means 8, and transmits these information from the corresponding antenna by the front end (including gathering date and time).

That is to say, the universal tuner 7 realizes tuning, front end, modulation, demodulation or the like of the signal, using the TV/radio (AM/FM) antenna 2, the antenna for mobile phone tuning, front end 3 (may be PHS) and the transceiver antenna 4 by means of one subminiature and light IC or a plurality of subminiature and light ICs. In this embodiment, the description will be made, assuming that one IC is used,

The controller 10c is for operating, at the time of inputting a telephone number, setting a channel of TV or radio, communicating with a transceiver, or acquiring position information by the GPS,

The control means 8 in the multiband transmitter-receiver 6 comprises, for example, a microcomputer, having a temperature monitoring section 8a, a heart rate monitoring section 8b, a position information acquisition section 8c, a first emergency judgment section 8d, a second emergency judgment section 8e, a voice conversion section 8f and a data transmission section 8g. For example, the first emergency judgment section 8d compares the temperature input by the temperature detection sensor 11a with the normal temperature of the jacket wearer stored beforehand in a memory (not shown), and when the temperature is unusually high, the data transmission section 8g transmits the temperature as the information from the mobile phone antenna 3 to either of the monitoring center or the wearers house, via the universal tuner 7.

In this transmission, it is preferable that the telephone number to be informed be set in advance, using the controller 10c.

Moreover, the second emergency judgment section 8e compares the heart rate detected by the heart rate detection sensor 11b with the normal heart rate of the jacket wearer stored beforehand in the memory, and when the heart rate is abnormal, the data transmission section 8g transmits the abnormal heart rate as the information in the same manner as described above. At this time, the second emergency judgment section 8e calls out via the speaker 10a, and if there is no response through the controller 10c, judges it to be an emergency (for example, heart attack), and transmits this matter from the mobile phone antenna 3. For example, the voice conversion section 8f spreads the information that the heart rate is unusually high to the speaker in speech. Similarly, the voice conversion section 8f spreads the temperature information from the temperature detection sensor 11a from the speaker (it is preferable that the temperature is informed when it is judged to be an emergency).

As a result, when a person wearing the jacket 12 collapses, a person nearby can judge the situation to some extent immediately, enabling taking appropriate measures quickly.

The sampling time of the above described temperature, heart rate or the like can be optionally set by the operation of the controller 10c.

Moreover, the temperature information from the temperature detection sensor 11a and the information of heart rate from the heart rate detection sensor 11b are stored in the memory, when the information is input for every certain time (for example, for every 10 minutes), and the information is transmitted at the time of emergency described above. This is for providing the information as the treatment data of the jacket wearer to the hospital.

When the vibration detection sensor 11c operates, it is judged that the jacket wearer has fallen or encountered a traffic accident, and the information of that matter is transmitted. When the water detection sensor 11d operates, it is judged that the jacket wearer has fallen into the sea or a river, and the information of that matter is transmitted. When either of the vibration detection sensor 11c or the water detection sensor 11d operates, the position information acquisition section 8c acquires the position information through the GPS antenna 5, and the data transmission section 8g transmits the position information together with other information from the mobile phone antenna 3,

As for the position information, it is set to transmit the information, for example, for every 10 minutes, the geographical information at this time can be used as the search information at the time when the jacket wearer collapses due to a heart attack or meets with a disaster.

When the abnormal state information is transmitted in response to the detection of each sensor, for example, the monitoring system installed in the hospital, and a fire station and the mobile phone in the wearers house are called via the radio network.

Each equipment in the above-described wearable multiband transmitter-receiver is attached to the jacket as shown in FIG. 2. This jacket 12 is waterproofed except a portion where the water detection sensor 11d is arranged. The TV/radio antenna 2 is sewed in the neck of the jacket 12, respectively, and the mobile phone antenna 3 is sewed in one collar and the transceiver antenna 4 is sewed in the other collar, respectively. The GPS antenna 5 is sewed in one shoulder portion of the jacket 12. The multiband transmitter-receiver 6 is sewed in one collar, and the I/O section 9 is sewed in the breast of the jacket 12.

Speakers 10a are sewed in the collar near the car, respectively, and the microphone 10b is used also as a button for buttoning up the collar, and the controller 10c and the liquid crystal display 10d are housed in a pair of pockets provided in the jacket 12. The temperature detection sensor 11a is sewed in the sleeve of the jacket 12 so as to abut against the side of the body, and the heart rate detection sensor 11b is sewed in the collar where the mobile phone antenna 3 is installed. The vibration detection sensor 11c and the water detection sensor 11d are sewed in below the I/O section 9. A pocket type battery 13 is also housed in a pocket on the right breast of the jacket 12.

Therefore, the communication from various antennas is controlled by the small and light universal tuner 7 (having a thickness of 1 cm, and a weight of about 30g), and various sensors, the controller and the like are connected to the universal tuner 7, with each equipment attached to an optimum place of the jacket. As a result, each equipment is not a hindrance to carrying, and various communication services can be utilized, without being sensible of wearing it.

When the health condition of the garment wearer is judged to be bad through the temperature detection sensor, or when it is known that the conditions of the garment wearer are bad via the heart rate detection sensor, and there is no response through the controller, it is possible to transmit the obtained information and the position information to either of a predetermined hospital, a fire station or the wearers house, thereby enabling treatment or search of the jacket wearer quickly.

In addition, when an abnormal state is detected through the vibration detection sensor or the water detection sensor, the information of that matter and the position information are transmitted to a predetermined hospital, a fire station or the wearers house, thereby enabling treatment or search of the jacket wearer quickly.

Furthermore, when an instruction to input the position information is received by the operation of the controller, the geographical information is taken into from the antenna section, and displayed on a display. As a result, the jacket wearer can know his/her current position, even if he/she is got lost.

<Second Embodiment>

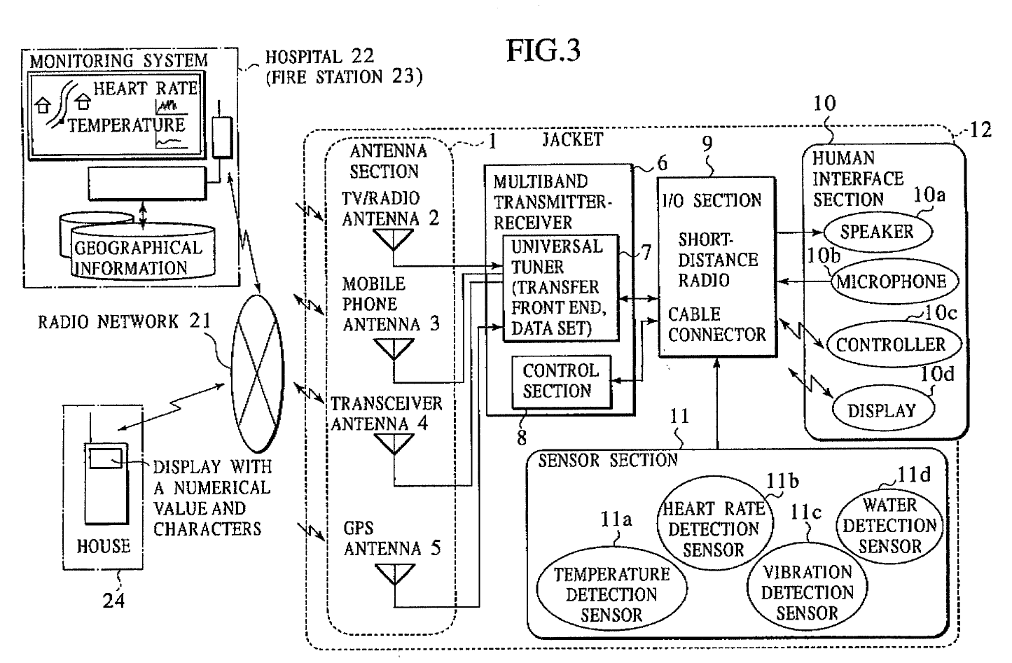

The jacket 12 with a multiband transmitter-receiver constructed described above is actually used with the system construction as shown in FIG. 3.

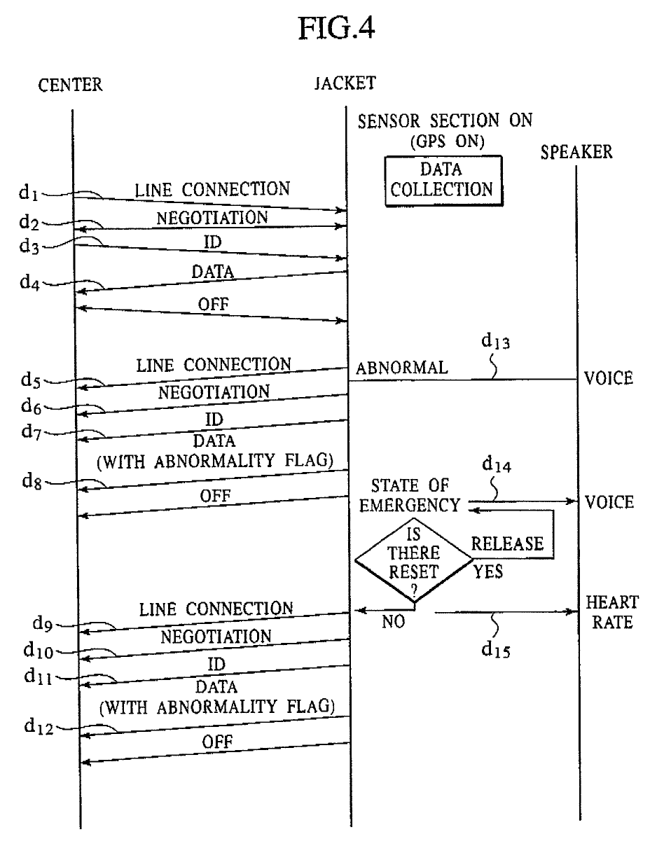

This FIG. 3 will be described as a second embodiment. FIG. 4 is a sequence diagram for explaining the second embodiment.

At first, the operation when using this transmitter-receiver in normal circumstances will be described, and then operation at an emergency will be described.

Since utilization of TV, radio, mobile phone and transceiver is a known technology, description of these operation will be omitted When using these functions, the wearer takes out the controller 10c housed in the pocket in the jacket 12, and performs key operation according to need. When using the TV or radio, the wearer selects a channel, and when using it as a mobile phone, he/she inputs the telephone number from the controller, and on the contrary, when there is an incoming call, he/she performs response operation with the controller In addition, when using the transceiver, transmission and reception become possible by operating a dedicated key.

On the other hand, the control means 8 in the multiband transmitter-receiver 6 gathers the information of temperature from the temperature detection sensor 11a and the information of heart rate from the heart rate detection sensor 11b and stores these information in the memory, since when this transmitter-receiver was switched on by the key operation of the controller 10c, to thereby perform time measurement. The respective information of the temperature and the heart rate is replaced with new information, every time the memory capacity determined beforehand becomes full. This capacity is a minimum memory capacity required for being useful as the treatment data of the jacket wearer.

When the above described measurement time has passed 10 minutes, the universal tuner 7 is controlled to gather the position information by the GPS to thereby transmit the information to the monitoring center of a hospital 22 via a radio network 21, which is repeated for every 10 minutes.

When transmitted to the mobile phone in each home, the data is transmitted in accordance with the mode of the mobile phone. When it is a mobile phone with an i-mode function, for example, the heart rate is transmitted in graphic data, and when it is a normal mobile phone, the heart rate and temperature are converted to speech and transmitted. As a result, the situation of the jacket wearer can always be known in each home.

Moreover, when receiving an instruction to gather the position information by means of the key operation of the controller 8, the control means 8 obtains the position by receiving the GPS information through the GPS antenna 5, and the position is output to the speaker 10a and informed in speech, as well as being displayed on the liquid crystal display 10d.

In the case where the call fee can be ignored, it is possible to transmit the various data to the monitoring center (hospital, fire station, athletic center or the like) by the above-described operation, but normally, the call fee cannot be ignored.

Therefore, it is preferred to communicate in a sequence shown in FIG. 4.

FIG. 4 is a sequence diagram in the case where it is set to a mode for transmitting various data to the center, using the controller.

As shown in FIG. 3, the center side comprises a geographic information system, and a monitoring system having a function for displaying an area map of the position data transmitted from the jacket 12, and a function of displaying in an analog format the temperature data, the heart rate data or the like.

Then, the center side makes a request for line connection with respect to the jacket 12 via the radio network 21 (d1), as required (timewise, or manually), and after line connection, negotiation is performed (d2).

Thereafter, ID of the center is transmitted (d3). The control means 8 of the jacket 12 has the gathered various data (temperature, heart rate, water, vibration, position and time) transmitted (d4), if the ID of the center is permitted.

The center side displays various data from the jacket 12 on the screen. For example, the center side decodes the position information and displays a map screen of the area of the position information on a reserve screen from the database, as well as displaying the jacket position by color. Moreover, the temperature, the heart rate or the like is displayed in a graph format,

As a result, a monitor of the center (for example, a doctor) can immediately understand the health status and the position of the person wearing the jacket.

Moreover, when judging an abnormal state, the jacket 12 performs line connection and negotiation with the center, using the mobile phone antenna 3 (d5, d6), and transmits the ID of the jacket 12 to the center (d7). The center authenticates the ID, and if it is the permitted ID, accepts the reception of the data.

Then, the jacket 12 transmits the various data (with an abnormal flag) at the time of judging an abnormal state to the center (d8).

At this time, the jacket 12 spreads the information of the heart rate, temperature or the like in speech from the speaker, when judging the abnormal state (d13).

Upon reception of the data with the abnormal flag, the center side displays the screen with a different color from that of the normal state. As a result, the monitor can immediately check the data, and take a necessary measure.

Moreover, when judging the emergency, the jacket 12 immediately informs from the speaker that an emergency has occurred (d14). For example, a sound different from that of abnormal state is generated. Then, if the reset button of the controller is not operated even after the generation of the emergency sound, the jacket 12 immediately performs line connection and negotiation (d9, d10), to thereby transmit the ID of the jacket 12 to the center (d11). The center authenticates the ID, and if it is the permitted ID, accepts the reception of the data.

Then, the jacket 12 transmits the various data (with an emergency flag) at the time of judging the emergency to the center (d12).

At this time, the jacket 12 spreads the information of the heart rate, temperature or the like in speech from the speaker, when judging the emergency (d15).

Upon reception of the data with the emergency flag, the center side displays the screen with a color indicating the emergency. As a result, the monitor can immediately check the data, and take a necessary measure, For example, the monitor knows the jacket position from the screen, and arranges to mobilize an ambulance to that position.

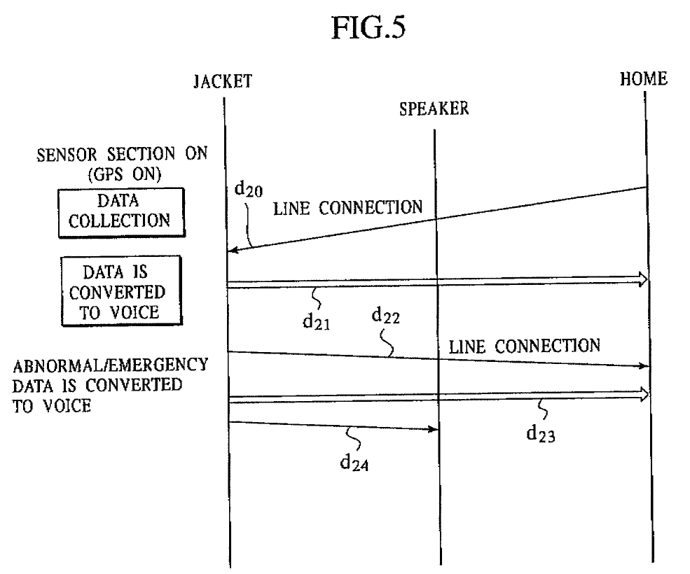

On the other hand, as shown in FIG. 5, in the case where there is a line connection from a mobile phone at home (d20), negotiation and authentication of the ID from the mobile phone are performed in the same manner as described above, and the gathered various data is converted into speech to thereby transmit the speech to the mobile phone (d22).

As a result, the health status and the position of the wearer can be known at home. In informing the position, the latitude and longitude are transmitted in speech.

Moreover, at the time of abnormal state or emergency, it is informed from the speaker that an abnormal state or emergency has occurred (d24).

For example, at the time of emergency, if the reset button of the controller is not operated even after the generation of the emergency sound, line connection and negotiation with the mobile phone at home are performed immediately to thereby transmit the ID of the jacket 12 (d22).

At this time, it is transmitted in speech that an emergency or an abnormal state has occurred, and various data is also transmitted in speech.

The operation at the time of emergency described above will be described further. When the temperature of the jacket wearer detected by the temperature detection sensor 11a exceeds a normal temperature stored beforehand in the memory, the physical condition is discriminated through the data stored in the memory. If it is judged that the discrimination result corresponds to an emergency, a telephone number of a predetermined hospital 22 registered beforehand is output to the universal tuner 7 to thereby transmit it. Thereby, when it is connected to the monitoring center of the hospital 22, the information of the abnormal temperature and the information of the temperature stored in the memory are transmitted.

When the heart rate detected by the heart rate detection sensor 11b exceeds the normal heart rate of the jacket wearer stored in the memory, calling out to the jacket wearer is performed through the speaker 10a. If there is no response from the controller 10c by means of the key operation, it is judged to be an emergency, and the telephone number of the hospital 22 is output to the universal tuner 7 to be transmitted. Thereby, when connection with the monitoring center in the hospital 22 has been made, the information of the heart rate at the time of abnormal state and the heart rate stored in the memory, and the information of the temperature stored in the memory are transmitted.

Then, the house 24 of the jacket wearer is called via the mobile phone antenna 3, and after the connection has been made, the aforementioned information is informed in numerical values and characters. If the telephone in the wearers home is a push-phone, these information is converted into a voice signal and transmitted.

When the vibration detection sensor 11c is operated, it is judged that the jacket wearer has fallen or encountered a traffic accident or the like, and when the water detection sensor 11d is operated, it is judged that the jacket wearer has fallen into the sea or a river. Then, the telephone number of a fire station (119) registered beforehand is output to the universal tuner 7 to be transmitted. After the connection with the fire station has been made, the information of that matter is transmitted. At this time, the position information by means of GPS is transmitted. Thereafter, the house 24 of the jacket wearer 12 may be called in the same manner as described above, to transmit the aforementioned information.

As described above, in this embodiment, since respective equipments constituting the wearable multiband transmitter-receiver are attached in an optimum position of the jacket, these do not become a hindrance to carrying, and various kinds of communication services can be used without being sensible of carrying it. Moreover, at the time of emergency, the information indicating the conditions of the jacket wearer is transmitted automatically to the hospital, fire station and the wearers house, and the geographical information is also transmitted. As a result, treatment or search of the jacket wearer can be quickly performed.

<Third Embodiment>

In the above described embodiment, since the information is to be transmitted to either of the hospital 22, the fire station 23 or the wearers house 24, via the radio network 21, these cannot know the situation of the wearer of the jacket simultaneously on a real time basis.

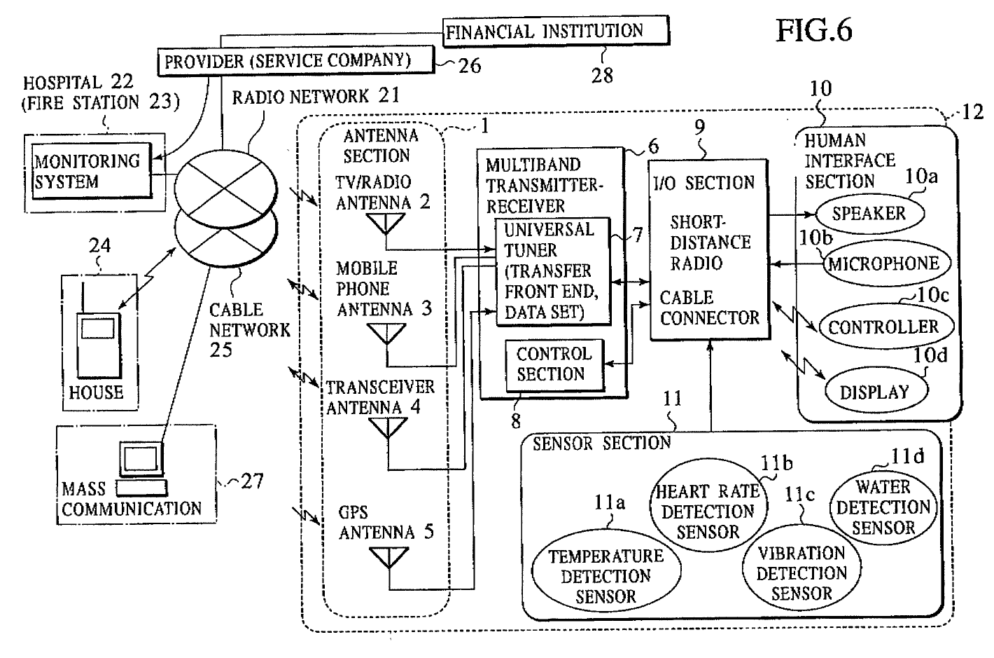

Therefore, as shown in FIG. 6, the multiband transmitter-receiver 6 in the jacket 12 communicates with a provider 26, using the mobile phone antenna 3, to thereby transmit the gathered data to the provider 26.

The provider referred to herein means a service company for providing the services described below on a network and a system of the service company.

That is to say, as shown in FIG. 6, the hospital 22, the fire station 23, the wearers house 24, or mass communication 27 may access to the provider 26, according to need, via a radio network 21 and a cable network 25 (Internet).

This provider 26 comprises a geographical information system, decodes the position data from the jacket 12 based on the geographical information, and informs where the jacket wearer is, For example, if the location is in a city, the data shows the location by an address, such as No. ##, A-chome, A town, A city. Also, if the location is in a mountain, the data shows B area, B-th station in Mount B. Therefore, the center side need not have the geographical information system.

Moreover, the provider 26 may comprise a distribution function to transmit the information at the time of emergency to the center or the wearers house. In that case, if a connection with the hospital 22 or the wearers house 24 cannot be made, the information at the time of emergency is temporarily stored in the provider 26 via the Internet 25, so that the information at the time of emergency is spread from the provider 26. Also, when the jacket wearer has met with a disaster in a mountain or on the sea, the information of that matter is gathered by the mass communication 27 or the like, together with the geographical information, as described above. This is because there is a possibility that new information required for search may be obtained.

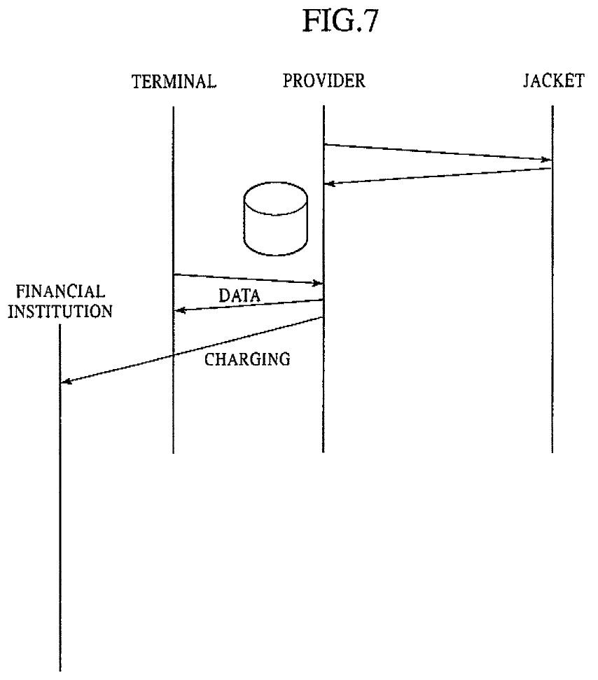

Furthermore, the provider 26 is connected to a financial institution 28, and regularly communicates with the jacket 12, to gather various data gathered by the jacket 12, as shown in FIG. 7.

The provider 26 also has a function to provide the gathered data, when a permitted terminal (center, home, mass communication) accesses the provider 26, and to deduct the amount corresponding to the charge from the bank account of the terminal owner.

In the embodiment of the present invention describe above, TV, radio, mobile phone, transceiver and GPS are used as the communication services. However, a function of amateur radio communications may be added to perform information exchange with a far field, or communication at the time of meeting with a disaster when climbing mountain, or the like. In addition, since a short-distance radio is built in the I/O section 9, connection with a fish finder (not shown) installed in, for example, a fishing boat may be made with radio transmission, to thereby display the information on a liquid crystal display 10d.

What is claimed is:

1. A jacket with a multiband transmitter-receiver function, comprising:
an antenna section having various antennas;
a sensor section for reading data such as at least temperature and heart rate of a wearer;
a multiband transmitter-receiver comprising a universal tuner for performing data set of a signal transmitted and received by said various antennas, and a control section for receiving maid controlling data detected by said sensor section; and
a human interface section intervening in exchange of information between said multiband transmitter-receiver and said wearer;
said antenna section being provided in the upper part of said jacket, and comprising at least a GPS antenna and a mobile phone antenna; and
said control section comprising:
an emergency judgment section for regularly gathering said data received in said sensor section, and comparing said data value with a predetermined value to thereby judge a state of emergency;
a voice conversion section for spreading said data value in speech from a speaker, when it is judged to be a state of emergency by said emergency judgment section;
a position information acquisition section for acquiring a position of said jacket, using the UPS data from said GPS antenna; and
a data transmission section for transmitting to the outside various data from said various sensors, said position of the jacket, and the date and time as the gathered data.

2. A jacket with a multiband transmitter-receiver function according to claim 1, wherein said various data are transmitted upon receiving a transfer request from an external device.

3. A jacket with a multiband transmitter-receiver function according to claim 2, wherein when said external terminal is a mobile phone, said gathered data is converted to speech and transmitted.

4. A jacket with a multiband transmitter-receiver function according to claim 1, wherein said emergency judgment section judges a state of emergency, when a reset signal from said controller is not input, even after a predetermined time has passed since said sensor value exceeded a predetermined value.

5. A jacket with a multiband transmitter-receiver function according to claim 4, wherein said data transmission section transmits said stored gathered data via said antenna section, when said emergency judgment section judges a state of emergency.

6. A jacket with a multiband transmitter-receiver function according to claim 1, wherein said sensor section has at least a temperature detection sensor and a heart rate detection sensor.

7. A jacket with a multiband transmitter-receiver function according to claim 1, wherein said human interface section has at least a speaker and a controller having various operation keys.

8. A jacket with a multiband transmitter-receiver function according to claim 1, wherein said universal tuner realizes data set of a signal transmitted and received by said various antennas, using a small and light transmission control IC.

9. A system comprising: a jacket provided with an antenna section having multiple kinds of antennas, a controller having various operation keys, a speaker, a signaling section, a temperature detection sensor, a heart rate detection sensor, and control means having a small and light transmission control IC for performing data set of a signal by said antenna section, respectively, in the optimum positions of said jacket, for regularly gathering and transmitting the information of these sensors; and various external devices for communicating via a network, wherein
said external devices comprise a geographical information system and have;
means for decoding the position information in the gathered data from said jacket, opening a map screen of the area at that position, and displaying said position by color; and
means for receiving said gathered data and displaying the data in a graph corresponding to said gathered data.

10. A system comprising a jacket provided with an antenna section having various kinds of antennas, a controller having various operation keys, a speaker, control means having a small and light control IC for performing data set of a signal by said various antennas, a temperature detection sensor, and a heart rate detection sensor, respectively, in the optimum positions of said jacket, for regularly gathering and transmitting the information of, these sensors; a network; and a provider for distributing said gathered data to various external devices accessed thereto, wherein
said provider comprises a geographical information system, and has:
means for decoding the position information in the gathered data from said jacket, allocating said position in a map of the area at that position, and upon receiving a request from said external devices, providing said gathered data in a format corresponding to the request from said external devices; and
means for charging a fee, when said system provides said gathered data in response to an access from said external devices.

11. A jacket with a multiband transmitter-receiver function, comprising.
antenna section having various antennas;
a controller having various operation keys;
a speaker;
a temperature detection sensor;
a heart rate detection sensor; and
control means,
respectively, in the optimum positions of said jacket,
said antenna section comprising at least a GPS antenna and a mobile phone antenna, these provided in the upper part of said jacket,
said control means having:
a small and light transmission control IC for performing data set of a signal, using said various antennas;
means for regularly gathering data from said various sensors, and when it is judged that said sensor value has exceeded a predetermined value, spreading said temperature and said heart rate in speech from said speaker;
means for acquiring a position of said jacket, using the GPS data from said GPS antenna; and
means for transmitting to the outside various data from said various sensors, said position of the jacket, date and time as the gathered data.
